(19) United States
(12) Patent Application Publication
(10) Pub. No.: US 2007/0050187 A1
(43) Pub. Date: Mar. 1, 2007

(54) Medical billing system and method

(76) Inventor: James Cox, Franklin, TN (US)

Correspondence Address: ERIC ROBINSON, PMB 955, 21010 SOUTHBANK ST., POTOMAC FALLS, VA, 20165, US

(21) Appl. No.: 11/214,036

(22) Filed: Aug. 30, 2005

(51) Int. Cl. G06F 17/27

(52) U.S. Cl. 704/9

(57) ABSTRACT

A probabilistic medical billing system and method using contextual data and inferential logic for use in screening accuracy of medical bill coding and for presenting results as probabilities or predictions of correctness. The probabilistic medical billing system and method is accomplished using the contextual information contained in a care givers' patient encounter notes, a set of rules and keywords, and an inferential, logic, engine based on Bayesian mathematics or similar disciplines. The inventive device includes an input device to capture care giver's encounter notes or other information, a lexical engine that extracts information while preserving the contextual order of the information, a relational database that contains keywords, phrases and rules and a statistical/probabilistic engine that uses Bayesian mathematics or similar disciplines to create the output. The lexical engine parses a document into words and is capable of extracting keywords or phrases as listed or defined in a master list. Further, the lexical engine would preserve the relative position of discovered keywords or phrases as the keywords or phrases and relative positions were encountered. The Bayesian engine is a mathematical algorithm that uses inferential logic to analyze historical data and shows the results as a predictive level as to the accuracy of a medical bill produced from the source documents. The inherent nature of Bayes like algorithms allows them to learn and improve their predictive capability through the use of a feedback system which is also part of the invention. Variations in algorithms and data flow can be easily made to support other predictive output related to billing or for the purposes of data mining and statistical evaluation.

### BACKGROUND OF THE INVENTION

1. Field of the Invention

The present invention relates generally to a system and method for medical billing. More specifically, the present invention relates to a probabilistic medical billing system and method using contextual data and inferential logic for determining the accuracy of medical bill coding and presenting results as a prediction of correctness. A medical billing system and method includes technologies also known as medical bill assistants, screeners or coders. The accuracy of medical bill coding and the presentation of results as a prediction of correctness may be accomplished, for example, by using contextual information contained in physician encounter notes, a set of rules and keywords, and a logical inference algorithm based on Bayesian mathematics or similar inferential logic disciplines.

2. Description of the Related Art

Medical billing is one of the most difficult processes in management of healthcare. The level of errors in billing has been estimated as high as 40% of all bills issued by doctors, hospitals, insurance companies and others. Billing errors are such an extensive problem that an entire industry has developed around auditing and readjusting medical bills. As a result, the healthcare industry incurs billions of dollars in additional expense each year.

Many factors contribute to complicating the process. Seemingly, one would think that a given procedure performed by a doctor or a hospital could be billed at an agreed upon price and that a total bill would simply be the sum of those individual procedure costs. However, this is not the case. Complicated combinations of procedures often result in different billing amounts. For example, if a doctor performs a procedure A and then, as a result of procedure A, was medically required to perform a second procedure B, then combination of procedures A and B would be billed, for example, as rate code X. Given the same patient and condition, if the doctor performed procedure A and then, as a precaution, performed procedure B, the precautionary performance of procedure B would be billed, for example, as rate code Y. In this example, an insurance company might not pay the complete amount for a precautionary performance of procedure B (rate code Y), but the insurance company might pay the complete amount for a medically necessary performance of procedure B (rate code X).

Regardless of which of the rate codes X and Y was correct, the bill is then submitted to the financially responsible party, often an insurance company. The insurance company now faces a dilemma. If the doctor submitted a bill under rate code X, then the insurance company probably does not know whether the second procedure B was a medical necessity after procedure A. In order to determine whether procedure B was a medical necessity, the insurance company would typically review doctors' notes on the encounter with the patient and then have their own medical expert decide if procedure B was medically necessary. The process described above is both costly and time consuming.

The insurance company is not the only one who can suffer in the example provided above. Doctors are often under-compensating themselves because they bill improperly or are completely unaware of a particular billing combination. The under-compensation is compounded in most medical practices as the doctor is rarely involved in the billing. Billing is left to the office staff who are not necessarily sufficiently trained and educated and may not have the expertise to know if a given set of procedures are in the correct sequence for a given code.

Across the various medical specialties, there are thousands of individual procedure codes and the combinations of codes make the billing process difficult. Since the list of codes and combinations is not static, the problem is compounded. Recently, because of medical advances, some medical specialties are performing procedures not normally in their specialty. Interventional radiology is a prime example. In the past, cardiac procedures that involved imaging were performed by cardiologists. Radiologists, in an effort to increase revenue, have modified cardiac procedures that involve imaging so that they can be performed by radiologists. This change created huge billing confusion and has resulted in companies being formed that do nothing but create bills for interventional radiology practices. With the kinds of billing processes described above, it is estimated that typically only 1 in 6 bills are correctly coded.

There have been a number of companies created to attempt to help the industry with the problem. These companies are quite varied but their approach to solving the problem typically fits into one of two categories, that is, post billing audits or pre-coding assistance.

Post billing audit companies usually work for either the insurance companies or the hospitals. They often examine a large block of billing data using typical data mining tools to find bills that fit a certain profile. Once these bills are identified, they are then manually examined by trained personnel in order to discover if they have been coded properly. If not, the audit company then issues a corrected bill in an attempt to recover the errant dollars. The post billing audit company usually keeps between 30-50% of the recovered funds for performing these services. Of course, these companies only re-bill in a way that favors their client. For example, if an insurance company overpaid a hospital, the audit company would issue a demand for repayment to the hospital. If, however, the same insurance company underpaid the hospital, no correction would be pursued. Some companies have subsidiaries working on the opposite side so that they are collecting money from both parties' mistakes. The post audit industry represents billions of dollars each year using the process described above; and these resources are extracted from healthcare and return no benefit to doctors or patients.

Pre-coding assistance companies can take on several forms, for example, direct processors that act as outsourced billing departments, training companies or software companies that seek to supply coding help through software based products, often referred to as coding wizards.

Outsourcing and training have the same advantages and disadvantages as their counterparts in other industries and could easily be supplanted by an effective software coding tool. The present invention provides a probabilistic medical billing system and method using contextual data and inferential logic adapted to deal with the above-referenced complexities of medical billing.

### SUMMARY OF THE INVENTION

Problems with the Current Art

There are a number of software tools available in the marketplace to assist with the proper coding of medical bills. However, these tools have some major drawbacks that keep them from substantially improving the billing process. These tools are known by several different monikers, for example, coding wizards, billing assistants, coding engines, and the like. For simplicity, this entire class of billing and coding software systems will be referred to as coding tools.

Most prior art coding tools are designed to assist the user in producing a valid medical bill through a number of devices, but the prior art coding tools typically offer some derivation of code lookups or code combination matching.

Code lookup tools are the simplest form of coding tools and merely convert a procedure to its appropriate billing code. The list of codes is contained primarily in two documents called the ICD-9 or CPT codes. Although these codes could be manually identified, the lookup process is still a difficult task for someone not well trained in the topic. There are two major drawbacks to this type of tool: 1) code lookup tools require the user to search for a code that can return many similar procedures without indicating which is more applicable, and 2) there is no information entered or retrieved with respect to combination codes.

Code combination matching tools are more sophisticated and make up the largest percentage of the currently available products. These coding tools include all the properties of the code lookup tools but carry the process further. These tools check combinations to see if they match specific pre-defined patterns. This allows the user to see if their grouping of codes is conflicting or is a typically acceptable combination. This has been very beneficial to small medical practices that tend to perform the same procedures repeatedly with only minor deviations. However, this model of tool quickly breaks down at the hospital level where many combinations of atypical procedures can be performed.

From a technical standpoint, these coding tools have several drawbacks as follows:

1) Prior art coding tools apply fixed logic to determine if the bill is correct. Their ability to learn new combinations is controlled by hard coding some combination or grouping.

2) Prior art coding tools ignore the context and order in which the actual procedures were performed and rely solely on the interpretation of the user.

3) Prior art coding tools seek an absolute (yes or no) result. If a procedure code combination has a number of acceptable possible answers, the user is faced with picking from a list of yes responses without knowing anything about the probability of being correct in their choice.

4) Users can miss subtle changes in procedure order or combination. The hard coded logic does not allow for dynamic feedback or observation of indirect variables.

As a result, prior art coding tools do not improve over time and with an increasing data set and are inflexible.

Specifically, medical billing assistants, for example, tools similar to 3M's Coding Reference Software, are lacking in the ability to deal with complex billing situations. As noted above, one of the biggest problems with existing tools is that they are primarily reference tools. There are a few tools that attempt to be coding wizards; however, the coding wizards all seek to apply fixed logic when determining the appropriate medical billing codes. The fixed logic methodology completely ignores the contextual information regarding the procedures performed on a patient and the sequence of those procedures. When coding a medical bill for payment, the sequence of the procedures performed can completely alter the codes needed to complete the bill properly. The vast majorities of people who work in the field of medical coding are not physicians and cannot interpret complex medical procedures or the context in which the procedures were performed. Using the existing tools, the only thing a user can do is find a procedure name and look up an associated code or associated codes. More than likely, the code or codes are out of context. As a result, bills are improperly coded and payments to physicians and hospitals are refused, delayed or inaccurate payment is received.

Also, conventional medical billing assistants or wizards generally seek an absolute answer and do not have provisions to deal with contextual information, that is, fuzzy information, that is often critical to producing an accurate bill. Human beings, when faced with complex problems or questions, choose answers based on their likelihood to be correct and do not rely on completely defined scenarios to evaluate every situation. Prior art coding products do not utilize fuzzy thinking, also known as inferential logic. Fuzzy logic is generally known to be defined as a form of algebra employing a range of values from “true” to “false” that may used in decision-making with imprecise data, such as in artificial intelligence systems.

Another problem with conventional medical billing assistants is that the assistants do not have dynamic feedback mechanisms to correct future predictions. Consequently, the same wrong result can be selected by individuals who do not have extensive enough coding experience to choose otherwise. Further, knowledge of the correct process is not easily passed to all potential users of the system.

In these respects, the probabilistic medical billing system and method using contextual data and inferential logic according to the present invention substantially departs from the conventional concepts and designs of the prior art and in so doing provides an apparatus primarily developed for the purpose of determining the accuracy of medical billing and presenting the results through inferential logic as probabilities or predictions of correctness.

In view of the foregoing disadvantages inherent in the known types of medical billing assistants now present in the prior art, the present invention provides a new probabilistic medical billing system and method using contextual data and inferential logic where the same can be utilized for screening the accuracy of medical bill coding and presenting the results as probabilities or predictions of correctness. Screening the accuracy of medical bill coding and presenting the results as probabilities or predictions of correctness may, for example, be accomplished using contextual information contained in physicians' or care givers' patient encounter notes, a set of rules and keywords, and an inferential logic engine based on Bayesian mathematics or similar disciplines.

The general purpose of the present invention, which will be described subsequently in greater detail, is to provide a new probabilistic medical billing system and method using contextual data and inferential logic that has many of the advantages over the medical billing assistants mentioned heretofore and many novel features that result in a new medical billing and screening tool/assistant which is not anticipated, rendered obvious, suggested, or even implied by any of the prior art medical billing assistants, either alone or in any combination thereof.

To attain the objectives of the present invention, the present invention may comprise an input device to capture the physicians' or care givers' patient encounter notes or other information, a lexical engine that extracts information from the input and preserves the relative order of the information, a relational database that contains keywords, phrases and rules and a statistical/probabilistic engine that uses Bayesian mathematics or similar inferential logic to create the output.

The lexical engine parses a document into words and is capable of extracting or marking keywords or phrases as listed or defined in a keyword/phrase/rule database. Further, the lexical engine's identification of keywords or phrases is adapted to retain the relative position of the items of interest, for example, the keywords or phrases and relative positions of the same as discovered in the document.

The Bayesian engine, or the like, is a mathematical construct based on inferential logic that processes the input and shows the results as a statistically based confidence level or prediction. An inferential logic algorithm allows the system to learn based on feedback which greatly increases accuracy and reduces false positive indications. There are many variations of the Bayes algorithm which could be loaded to suit the circumstances and needs of the user. An interactive system that allows for the input of new rules as well as the modification of existing rules can be used to further fine tune the output of the engine probability profiles. Such inferential logic algorithms are well known to those of ordinary skill in the art.

There has thus been outlined, rather broadly, the more important features of the invention in order that the detailed description thereof may be better understood, and in order that the present contribution to the art may be better appreciated. There are additional features of the invention that will be described hereinafter.

In order to improve current coding tools, a probabilistic medical billing system and method using contextual data and inferential logic is provided herein adapted to perform one or more of the following functions:

A primary objective of the present invention is to provide a probabilistic medical billing system and method using contextual data and inferential logic that overcomes the shortcomings of prior art devices.

Additional objectives of the invention include but are not limited to the following:

A system or method adapted to indicate the accuracy of medical bill coding or screening and present the results as probabilities of correctness based on statistically significant patterns or predictive processes using a Bayes or other type inferential logic algorithm.

A system or method adapted to improve the accuracy of medical bill coding or screening by using contextual and/or positional data from notes, procedures or other similar sources related to a patient encounter.

A system or method adapted to use a lexical engine to match, mark or record system stored keywords or phrases contained in inputted text while preserving their relative position within the text.

A system or method adapted to improve the accuracy of medical bill coding or screening by providing a feedback mechanism that allows the inferential logic algorithm(s) to assimilate or learn new patterns or adjust existing patterns.

A system or method adapted to quickly assimilate patterns from subject matter experts resulting in additional coding and screening capabilities.

A system or method adapted to quickly load rule sets, keywords and phrases from other similar systems to improve accuracy or capability.

A system or method adapted to operate as a central system or method and to be used by multiple users to create a larger statistical base thus improving the accuracy of billing and screening.

A system or method adapted to be used in parallel or in series with similar or dissimilar systems to add additional screening or coding capabilities.

A system or method adapted to use other keywords, phrases and rule sets of a non-medical type such as contractual relationships or quality measurements in order to improve billing.

A system or method adapted to be supplied with new keywords, phrases or rule sets remotely via the internet or other network.

A system or method adapted to be used to process or screen large numbers of bills automatically and without user input.

A system or method adapted to note other statistical patterns not noticed or supplied by the user as a result of using inferential logic.

A system or method adapted to be used in the creation of the initial bill(s) or as an input device to other billing or processing systems.

A system or method adapted to use the contextual information contained in a doctors' encounter notes (or other source) without the need for human interpretation in every case.

A system or method adapted to be able to directly couple the contextual information with known combinations that meet acceptable code groupings.

A system or method including a means for the system or method to learn about new billing scenarios through user or automated feedback.

A system or method adapted to be capable of observing subtle changes in combinations and alerting the user to new trends or discrepancies.

A system or method adapted to return the results of billing combinations as a probability of being correct as opposed to an absolute yes/no choice.

A system or method adapted to be able to train the system or method when new areas, specialties or cross over procedures emerged.

A system or method adapted to be able to account for other factors in the billing combinations such as contracted rates or other non-medical influences.

A probabilistic medical billing system or method using contextual data and inferential logic is provided herein and may be adapted to encompass any combination of one or more of the objectives listed above.

Other objects and advantages of the present invention will become obvious to the reader and it is intended that these objects and advantages are within the scope of the present invention.

To the accomplishment of the above and related objects, the present invention may be embodied in the form illustrated in the accompanying drawings, attention being called to the fact, however, that the drawings are illustrative only, and that changes may be made in the specific construction illustrated.

### BRIEF DESCRIPTION OF THE DRAWINGS

Various other objects, features and attendant advantages of the present invention will become fully appreciated as the same becomes better understood when considered in conjunction with the accompanying drawings, in which like reference characters designate the same or similar parts throughout the several views, and where:

FIG. 1 is a basic integration diagram.

FIG. 2 is a diagram of lexical engine routines.

FIG. 3 is a diagram of an input/feedback component.

FIG. 4 is a diagram of a computer system.

FIG. 5 is a diagram of a parallel system configuration.

FIG. 6 is a diagram of a series system configuration.

FIG. 7 is a diagram of a series system configuration with first and second routines.

FIG. 8 is a diagram of a combination of a series and parallel system configuration.

### DETAILED DESCRIPTION OF THE INVENTION

Constructing a Probabilistic Medical Billing System and Method Using Contextual Data and Inferential Logic

In order for one to construct a probabilistic medical billing system and method using contextual data and inferential logic that encompasses the features listed earlier, one or more features may be incorporated as follows:

1) An input device, such as an input device capable of accepting a doctors' encounter notes and rendering them in an electronic format using OCR or other recognition or digitizing systems.

2) An input analysis system or method, such as an input system or method capable of reading the encounter notes, looking for keywords, phrases or other significant information, and storing the same in a keyword database. This sub-system may also be capable of assigning a relative importance to these key items as well as storing the position (or order) of where the item was found in the document.

3) A database of billing codes and combinations.

4) An inferential logic algorithm that may be adapted to couple the contextual data with the billing code combinations to produce an output representing the probability that a particular bill was coded correctly. The inferential engine may be adapted to provide for automatic feedback and/or a mechanism to train the system to identify new combinations. Additionally, the engine may be adapted to have the capability of reporting on variables not directly observed.

5) A user interface, such as a user interface adapted to handle the physical generation of a bill and provide an access point for feedback or training and other control functions.

In order to more accurately describe the construction of the probabilistic medical billing system and method using contextual data and inferential logic, it is necessary to further define each of the mentioned components and to show their integration. For clarity, the invention can be thought of as the combination of generalized systems as follows: 1) contextual collection and processing, and 2) inferential processing and feedback. Once these two areas are more clearly explained, they can be uniquely combined to produce the present invention.

Contextual Collection and Processing

A. Data Collection

The first component facilitates the input of the doctors' encounter or operative notes and could utilize any number of different paths or devices. Physician notes are often handwritten so one suitable method would be to scan the document and use some type or OCR system to turn the document into an electronic version preserving the individual words, their order and their punctuation. The notes could also be directly typed into the system or delivered to the system from some other electronic source that produced a document or data stream in a machine readable format.

In addition, it should be noted that there would be no limitation on the documents that could be added to the system for further processing consideration. For example, medical records, lab reports or even insurance contracts often have a direct impact on medical billing. For simplicity in explanation, the physician operative or encounter notes are used in the discussions herein as an example since they are often essential to the process and often excluded.

B. Converting and Processing the Contextual Data

As described earlier, some of the most critical aspects of correctly generating a medical bill are as follows: (a) knowing what procedures were performed, (b) knowing the order in which the procedures were performed, and (c) determining a relationship between procedures and their order by observing phrases, such as “was needed” or “necessitated,” for example.

Accomplishing the above task may require three sub-systems: a lexical parser, a database of important keywords, phrases, punctuation or symbols, and a software application to handle the processing.

A lexical parser is software that is capable of being programmed to process an electronic document by examining words, phrases or punctuation in the document and often includes the capability to tokenize the document. Tokenization is the process of turning sequences of characters into tokens that are understood by a computer program.

Further, the lexical parser may use a method that allows for the preservation of the relative position of words, phrases and punctuation on the page. A simple numbering system could be used by assigning an increasing value to the words as they appear on the page, for example. Alternatively, processes that are more complicated could be employed as replacements or enhancements to the system. For example, the use of natural language algorithms to speed up processing or some enhanced mechanism that would use multi-level tokenization to increase the granularity or accuracy of the system are examples.

Lexical parsers are readily available in the marketplace and even come as part of the Java programming language which is in widespread use.

A second component is a multi-table database of keywords, phrases, punctuation and symbols that are relevant to processing medical bills. This will be referred to as the keyword database for simplicity. The keyword database would contain the aforementioned keywords, phrases, and the like, as well as associated data such as billing codes for procedure type keywords or phrases or translations of symbols, for example. These tables and lists could be constructed using several possible methods such as the following:

1) Single or multi word procedure descriptions could be associated to their widely published medical billing codes.

2) Phrases, and the procedures they are commonly associated with, could be gathered electronically from encounter and operative notes using a full text search methodology and a statistical analysis of the results.

3) Doctors or other medical experts could provide lists of typical terminology used in their respective specialties.

4) Medical dictionaries could be added for symbol resolution or keyword additions.

Many other sources and methods could be used to gather, modify or add to this database but the goal would be to populate the database in such a way as to allow for the accurate tokenization of the physicians encounter or operative notes.

The last item needed for contextual note processing is a software program that accepts the results of the lexical parser, compares words and phrases in the parsed notes to the keyword database and produces an output that would serve as an input to inferential portion of the system. This will be referred to as the combining software.

The process by which the combining software operates may be varied, but the simplest methodology is to iteratively process the document looking first for keywords, then for phrases, then punctuation, and the like. This would allow for such situations as an important keyword that was also part of an important phrase.

The output from the combining software could contain such information as:

1) Keywords, their relative position in the document and associated data such as common medical billing code(s).

2) Phrases, their relative position in the document, associated billing code(s) if any.

3) Punctuation connected with the keyword or phrase and its relative position.

4) Symbols, their position and translation either to keywords or phrases that would be processed as in items 1 or 2 above.

As a very simple example, consider the following physician operative note:

“Procedural cardiac bypass was performed on patient as a result of coronary thrombosis. The patient was also screened via angiogram as is department policy.”

After passing this document through the system described thus far, the expected output could be similar to the following (for simplicity sake, the relative position in the document is simply the integer count as the relative position appears in the text):

TABLE 1

| KEYWORD OR PHRASE | CODE(S) | POSITION |
|---|---|---|
| Cardiac bypass | 1234 00 | 2 |
| Performed | n/a | 5 |
| Patient | n/a | 7 |
| Result | n/a | 10 |
| Coronary thrombosis | 1234 00-06 | 12 |
| Patient | n/a | 15 |
| Screened | n/a | 18 |
| Angiogram | 1281-04 | 20 |
| Department policy | n/a | 23 |

On the surface, although it might appear this could be enough information to create an accurate bill, it is not. There are many subtleties that could be included, but the present invention recognizes two desirable additional features:

1) The code for the angiogram is not similar to the codes for the cardiac procedures. Is the procedure allowed? If this procedure code was a radiology code for example, are cardiologists allowed to bill for this procedure either by contract or regulation? Is there some other code or modifier that should be considered in order to submit an acceptable bill?

2) The angiogram was performed as part of hospital department policy. In the eyes of this patients' insurance company or Medicare coding standards, is that allowed? If so, how is that correctly indicated on the bill?

To process this scenario correctly, the present invention includes additional functionality which leads to the explanation of the inferential portion of the invention.

Note: The previous example does not involve the use of punctuation or symbols but the importance can be illustrated by the following change in the first sentence or the physician note:

“As a result of a cardiac thrombosis, a coronary bypass was performed.”

Despite the difference in relative position of the keywords, the comma can be used to infer the earlier version. This is a good example of how natural language algorithms are used in the present invention to decipher this difference and enhance processing.

Inferential Processing and Feedback

The second major portion of the system relies on the use of inferential logic algorithms, also known generally as machine learning, and feedback mechanisms that support the learning or training of the inferential components.

Machine learning encompasses a large body of work that has been studied seriously since the 1940's work of Alan Turing. There are many mathematical processes and algorithms that have been developed around the various machine learning methods. Artificial neural networks, for example, are often discussed in the popular press surrounding the future of robotics. These algorithms are also particularly useful in dealing with complex analysis, such as face recognition, and other areas where the result may be expressed as a probability of correctness. Further, one of the trademarks of this type of algorithm is that the algorithm learns or improves the output of the algorithm as more and more possible outcomes are explored and the results returned to the system in the form of feedback on their correctness.

Inferential logic is a general term that is applied to certain machine learning algorithms that can use direct and indirect information to infer a result. There are many such algorithms such as artificial neural networks, decision tree learning and Bayesian learning to name a few. These or other learning type algorithms could be adapted for use in the invention; however, Bayesian learning has several properties that are particularly useful and have been adapted to the present invention. Consequently, the discussion going forward will use Bayesian Learning to more fully describe the inferential algorithm and its integration into the invention.

A. Bayesian Learning

Bayesian systems are based on the Bayes Theorem which was first defined by the Reverend Thomas Bayes in 1791 and later by the mathematician Laplace. The Theorem was mainly considered a mathematical curiosity for some time until its recent re-discovery in applications devoted to machine learning and artificial intelligence.

The Bayesian system of reasoning, or learning, is based on the assumption that the data of interest is governed by some probability distribution and that optimal decisions can be obtained by combining these probabilities with observed data. The Bayesian system also provides a way for learning type algorithms to manipulate the related probabilities and can serve as a platform for analyzing the results of algorithms that do not manipulate probabilities directly.

Some of the major features of a Bayesian System are as follows:

1) Each training example input into the system can incrementally increase or decrease the probability of an observation as being correct. Most other algorithms completely eliminate examples that do not support all the aspects of any particular example.

2) Prior knowledge can be used with observed data to change the probability of any given hypothesis.

3) Bayesian systems can make use of hypotheses that make probabilistic predictions.

4) New hypotheses can be created directly by combining predictions from other hypotheses along with a weighted probability for each prediction.

As one can see from items 2 and 4 above, combination with observed data and the creation or weighting of existing hypotheses, could be accomplished through the use of a feedback mechanism that would transmit the results of prior calculations back to the input of the system.

B. Bayesian Engines

Within the general category of Bayesian systems, are a number of algorithms that are all based on the original Bayes Theorem. The Bayes optimal classifier, Gibbs algorithm and Naïve Bayes Classifier are just a few examples. New algorithms, and new uses for old ones, are being researched on a continuous basis. Of late, there has been a substantial amount of work with the Naïve Bayes Classifier which has resulted in a number of commercial products, chief of which has been email spam filters. The use of this algorithm has become prevalent enough that there are now commercial versions of the Bayes Classifier, usually called Bayes engines, available. (for example see www.bayes.com).

For the purposes of this invention, and ease in description, the focus will be on the use of a commercially available Bayes Engine that can be programmed to accommodate the inventions needs. Consequently, a detailed description of the derivation and direct manipulation of Bayes Theorem is not presented here. Further, upon closer scrutiny, one would discover that commercial Bayes Engines are flexible enough to accommodate other algorithms besides the Naïve Bayes Classifier which leaves the invention open to the easy substitution of algorithms that could improve the inventions performance or output.

Integration and Use

Now that the major components have been described, the next step in the process is to integrate the components and outline their general use.

Generally speaking, a probabilistic medical billing system and method using contextual data and inferential logic may comprise an input device to capture the care givers' patient encounter notes or similar information, a lexical engine that extracts or marks words and phrases while preserving the relative order of the information, a relational database that contains keywords, phrases and rules and a statistical engine that uses Bayesian mathematics or similar disciplines to create an output. The lexical engine parses a document into words and is capable of marking or extracting keywords or phrases as listed or defined in keyword/phrase table or list. Further, as the lexical engine discovers keywords or phrases, the lexical engine would retain the relative position of the items of interest in the input document.

There are several variations of the Bayes inferential logic algorithm which can be loaded to suit the circumstances and needs of the user. Its purpose in the present application is to provide a confidence level or prediction as to the correctness of the bill in question with respect to bills related contextual information. The results are based on comparison to previous encounters and are expressed as a probability of being correct or incorrect. Specifically, the contextual output data of the lexical engine is supplied to the Bayes engine along with a bill to be checked. The engine, through inferential logic, compares the current bill and contextual data to similar billings and contextual data of past encounters. The results are a confidence level prediction as to the likelihood the resulting bill is correct. A confidence level prediction is not to be construed as simple pattern matching. Despite having similar encounters, no two people are likely to have described all the aspects of that encounter in exactly the same way. The inference engine is capable of determining the probability that the given encounters are the same despite the differences in the encounter descriptions.

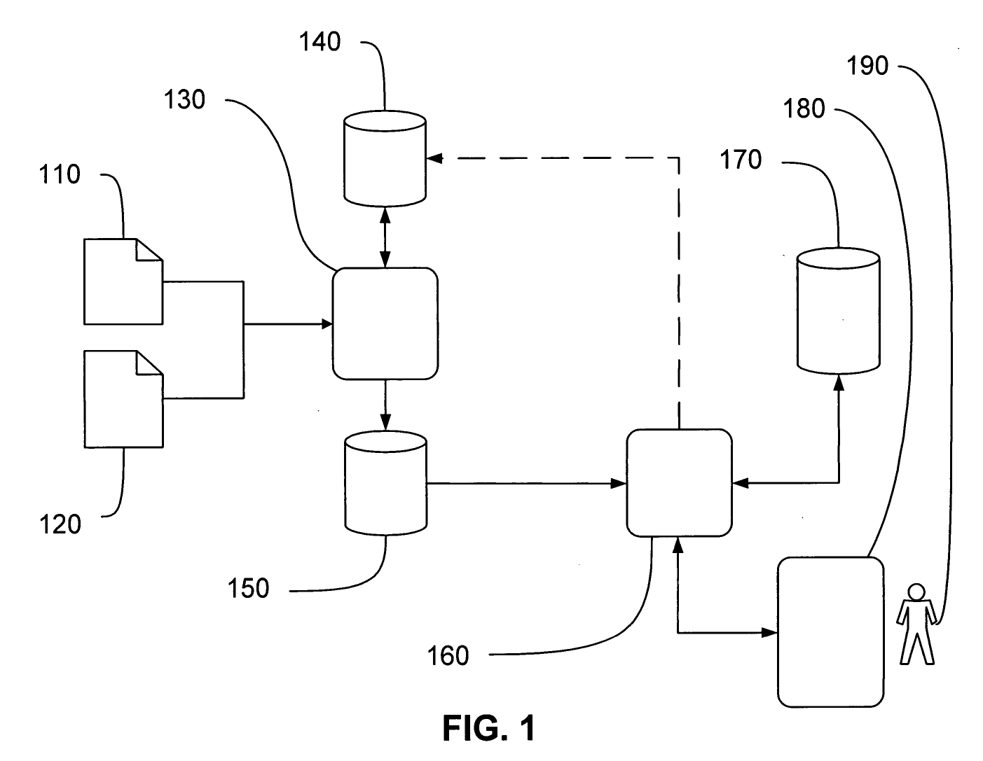

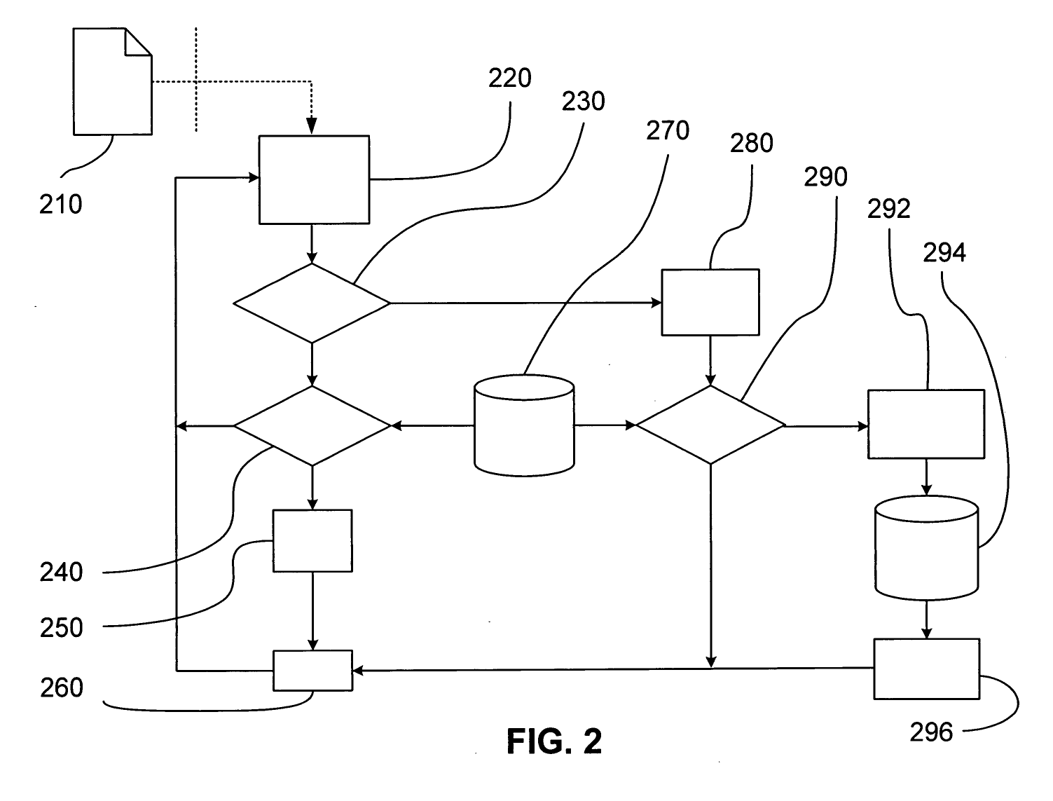

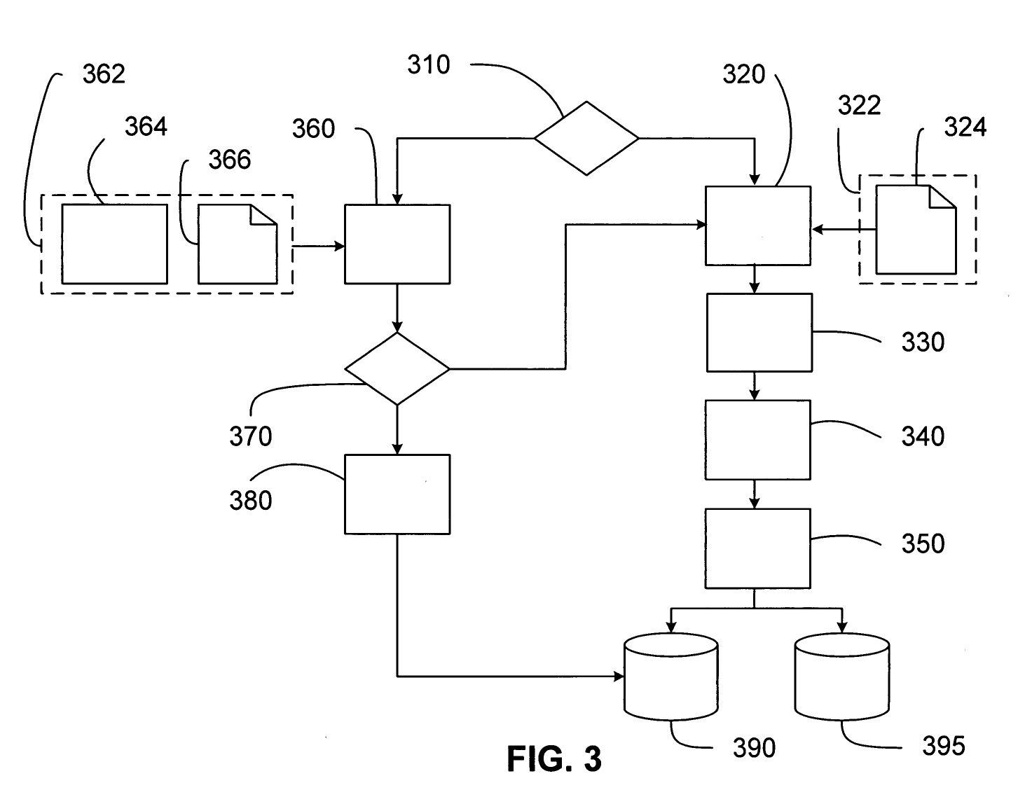

FIG. 1 illustrates one embodiment of a probabilistic medical billing system and method using contextual data and inferential logic, which may comprise one or more of the following components: medical notes or information 110 and/or medical services billing information from other systems or user input 120 may be inputted into a lexical parser and input processing system or lexical engine 130. The lexical engine 130 is adapted to receive input from a collected database of keywords, phrases and related terms of interest 140. The lexical engine 130 may include a routine, which is described in detail below and in FIG. 2. The lexical engine output 150 may be a stream of extracted keywords, phrases and related terms of interest and the relative order of the keywords and phrases from the original document may be preserved. Relative order may be the numerical order in which words appear on a page or within a series of pages, or relative order may be an actual position on a page using horizontal and vertical axes to identify the position on the page. The output of the lexical engine 130 may be collected in a separate database 150 prior to input into a process engine or Bayes engine analysis and processing system 160. The Bayes engine 160 will be described in greater detail below. The Bayes engine 160 may be adapted to integrate with a database 170 comprising process engine rules, billing codes, patterns, experiential results and the like. One form of output from the Bayes engine 160 may be directed as feedback with new and modified keywords and phrases into the collected database of keywords, phrases and related terms of interest 140 to further improve the overall system or method. Another form of output from the Bayes engine 160 may be directed to a user interface 180 which is adapted to display results to a user 190, so that the user 190 may select or reject a result by probability or modify the results in any suitable manner. The user interface 180 may include an input/feedback component, which is described in detail below and in FIG. 3. The user-identified results from the user interface 180 may also be sent back into the database of keywords, phrases and related terms of interest 140 to further improve the overall system or method.

Generally speaking, the lexical engine or lexical analyzer 130 converts an inputted document or character stream into recognizable words. Then, as the analyzer moves through the word stream, the analyzer compares the current word to a set of relevant keywords or phrases looking for matches. Keywords can be procedure names, billing code or any other word that is significant with respect to the inputted document. If the engine discovers a matching word, the engine then reads the next word and researches a list of phrases looking for any partial match. The process of reading the next word and looking for matching phrases continues until the next word the analyzer reads does not reflect a corresponding phrase. On either single keywords or phrases, the analyzer indexes the keyword or phrase so that its relative sequence in the word stream is known. The results of all the found keywords, phrases and relative positions are written to a database for further analysis by the statistical (Bayes) engine. In addition, if procedure type keywords were present, the corresponding billing code and sequence may be stored for analysis as well. Variations to the lexical engine and process are possible including improved or different algorithms for parsing the document, finding keywords and phrases and the use of iterative algorithms to improve performance. The lexical engine could also use natural language algorithms to improve the engines ability to produce a more significant output with respect to the contextual meaning of a phrase or word grouping.

FIG. 2 illustrates one embodiment of a lexical engine routine, which may be adapted for use with the lexical engine 130, described above.

In step 210, an electronic document or other input is provided to a lexical parser or lexical engine, such as engine 130, and the routine proceeds to step 220.

In step 220, the lexical parser or lexical engine, such as engine 130, reads words sequentially from the electronic document or other input from step 210, and the routine proceeds to step 230.

In step 230, the routine queries whether a keyword or phrase marker has been set. If the result of the step 230 query is NO, then the routine proceeds to step 240. If the result of the step 230 query is YES, then a new word has been identified and the routine proceeds to step 280.

In step 240, the routine queries whether a keyword or phrase is of interest, which is determined by comparing the keyword or phrase against a database of keywords or phrases of interest 270, to be described below. If the result of the step 240 query is NO, then the routine proceeds back to step 220. If the result of the step 240 query is YES, then the routine proceeds to step 250.

In step 250, the routine sets a keyword or phrase marker and adds a word to a substring of interest, and the routine proceeds to step 260.

In step 260, the next word is read, and the routine proceeds back to step 220.

As noted above, if a new word has been identified, then step 280 is initiated. In step 280, the routine adds the new word identified in step 230 to a substring of interest+the new word, and the routine proceeds to step 290.

In step 290, the routine queries whether substring of interest+the new word identified in step 280 are in the database of keywords or phrases of interest 270. If the result of the step 290 query is NO, then the routine proceeds to step 292. If the result of the step 290 query is YES, then the routine proceeds back to step 260.

In step 292, the routine stores the substring of interest+the new word with document contextual position information in a database 294 containing keywords, phrases and contextual position information, and the routing proceeds to step 296.

In step 296, the routine clears the keyword/phrase marker and proceeds back to step 260.

Generally speaking, an input/feedback system (FIG. 3) provides an interactive means for the user 190 to enter new rules, keywords or phrases for the lexical engine 130 or to modify patterns and their conclusions for the Bayes engine 160. In general, the user would compare the Bayes prediction output of correct coding as compared to the actual bill generated from the input encounter. If the bill is correct, the Bayes engine adds the data to its history tables in order to reinforce the current rule and increase the confidence level of similar predictions in the future. If the bill is incorrect, the user is presented with the care givers' encounter notes, or other input document, as processed by the lexical engine with the keywords and phrases the engine found indicated within the frill text of the document. The user can then highlight/de-highlight the keywords or phrases that should have been considered for the bill to be correct. The corrections would then be recorded with other historical data that supplies the Bayes engine. In the case of a new set of rules, the user can directly enter the keywords and phrases into the lexical engine database and enter the new rules/conclusions directly in the Bayes engine database using the same feedback system. The larger the statistical base grows, the more accurate the probabilities generated will be.

A lower limit on acceptable probability can be set which would trigger an alert to the user to review the bill. If the output probability is low, a feedback mechanism that allows the user to review the information and correct the final output would enable the engine to learn as the engine is used: Subject matter experts could use the feedback mechanism in rapid succession to establish the initial database or quickly improve the accuracy of established rules. Other inferential logic models or algorithms could be used to improve the accuracy or performance of the system. The output of other systems could be added to the keyword and rule database giving the engine a much larger statistical base to use in comparisons. Multiple engines could be coupled to check for other probabilities of interest that use the same data but are operated to examine other areas of interest such as disease outcome, drug use or other details associated with medical billing.

FIG. 3 illustrates one embodiment of an input/feedback system, which may be adapted for use with the lexical engine 130 or the Bayes engine 160, described above.

In step 310, the system queries whether a user wishes to provide a new entry or modify an existing entry. If the result of the step 310 query is NEW, then the system proceeds to step 320. If the result of the step 310 query is MODIFY, then the system proceeds to step 360.

In step 320, the system displays a full document from the lexical engine 130 with keywords and phrases highlighted, and the system proceeds to steps 330-350. The full document may be received from an input source 322, which may include, for example, physician notes processed by the lexical engine 130, but may include any other suitable type of input.

In step 330, a user highlights new keywords, phrases or rules to add or modify a conclusion generated by the Bayes engine 160, and the system proceeds to step 340. In step 340, a user enters correct billing code conclusions, and the system proceeds to step 350. In step 350, a current probability conclusion is added or modified, and the results are outputted into a database 390 including previous data steams, results and rules for the Bayes engine 160, and a database 395 including updated keywords and phrases for the lexical engine 130.

As noted above, if the result of the step 310 query is MODIFY, then step 360 is initiated. In step 360, a manual or automated comparison is performed. Specifically, for example, data is received from an input source 362, which may include output 364 from the Bayes engine 160 and/or an electronic bill or output 366 from a separate billing system. The system may electronically compare the data to an actual bill generated from the input encounter, or the system may allow the user to manually compare the data to an actual bill generated from the input encounter, and the system proceeds to step 370.

In step 370, the system queries whether the bill is correct based on the comparison made in step 360. As with the step 360 comparison, the query may be electronic or manual. If the result of the step 370 query is YES, then the system proceeds to step 380. If the result of the step 370 query is NO, then the system proceeds back to step 320.

In step 380, the system updates the Bayes engine 160 to enforce the probability conclusion, and the system updates the database 390 including previous data steams, results and rules for the Bayes engine 160.

A. General Operation

The general operation of the system is largely automatic and could require little direct input from the user. The basic steps are as follows:

(1) The user would supply the system with one or more copies of physicians' encounter notes. These notes could be loaded into the system manually through scanning/OCR or electronically from some other system or process. If, for example, a bill for the physicians' or care givers' services has already been produced by an external process or system, then a copy in electronic format would be loaded as well.

(2) The lexical engine would then automatically parse the documents and look for keywords, phrases or other significant combinations as defined in the keyword/phrase database table(s). Matching items in the document would then be indexed as to their relative position within the document and saved in a results database table.

(3) The Bayes engine, or other statistical engine, would then scan all historical results files utilizing the codes from the physicians'/care givers' bill along with the data from the current lexical engine result table. The Bayes engine would then process the information using a Bayes, or similar, based algorithm in order to determine the likelihood that the physicians' bill is coded correctly and/or would display the probability of the current bill as compared to other possible deviations. Output may opticmally be presented in a percent confidence level.

(4) Upon viewing the results from step 3, either the user could accept the current bill as is or could supply feedback to the system in order to correct or influence the systems resulting output for future bills.

(a) If the bill was correct, the lexical engine results and the physicians' bill information would simply be added to the results history table(s).

(b) If the bill was incorrect, the user would then be presented with an image of the physicians' encounter notes with all the keywords and phrases the lexical engine identified highlighted. The user could then indicate additional keywords or phrases that should have been considered when checking the current bill or could accept the document unchanged. The user would then be presented with the physicians' bill and could indicate differences in a similar fashion to the notes. All changes would then be recorded in the results history table(s).

For clarity in this description, the system has been preloaded with whatever data is necessary to carry out its function. This would include such things as loading the Keyword database, loading all the ICD-9 or CPT codes in the Bayes Engine support database as well as loading various historical billing information and outcomes. The input may be that of encounter notes or other medical information.

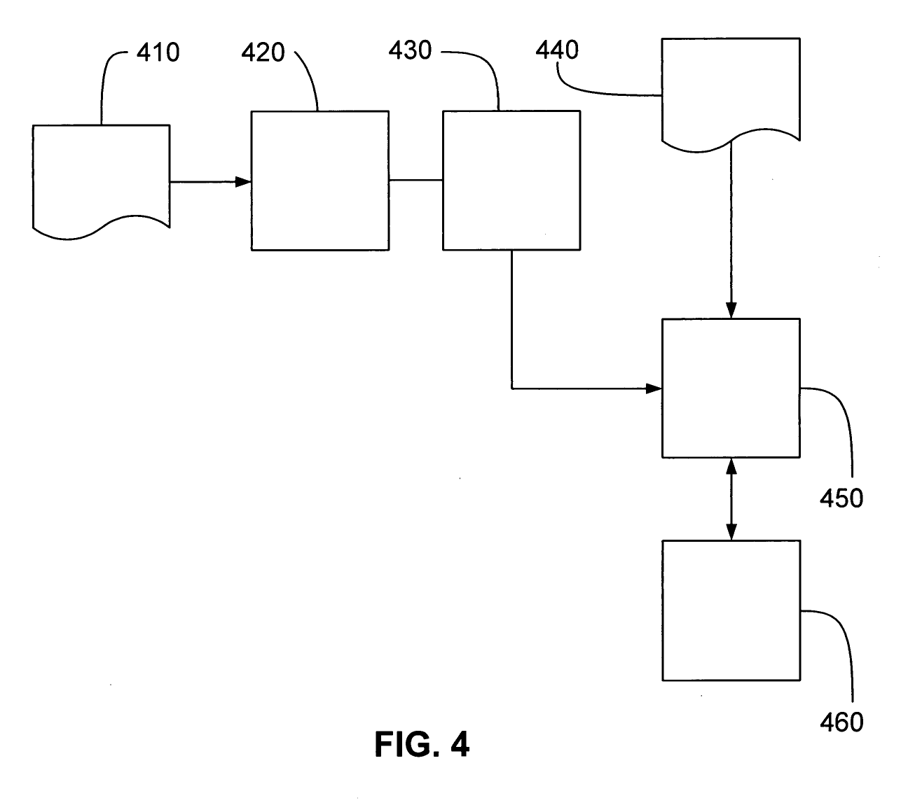

Specifically, for example, FIG. 4 illustrates a diagram of one embodiment of a computer system for implementing the present system and method. A Bayes engine, for example, the Bayes engine 160 as described in detail above, and a rules and results database, for example, the rules and results database 170 described in detail above, may be provided in a computer 450. The computer 450 may be provided with data from one or both of two sources.

A first source of data may be encounter notes or other medical information 410 which may be scanned with a scanner 420. The scanner 420 may be connected to a computer 430 comprising a lexical engine, for example, the lexical engine 130 as described in detail above, where the computer 430 is adapted to receive data from the scanner 420 and is further adapted to parse the document. The computer 430 may also comprise a keyword database, for example, the keyword database 140 as described in detail above. In the embodiment shown in FIG. 4, the computer 430 would be adapted to be connected to the computer 450.

A second source of data may be medical bills and/or medical billing information 440 from OCR or manual entry of other data processing, which may be directly inputted into the computer 450. The computer 450 may be adapted for connection with a user interface 460 in which a user reviews a bill expressed as a probability of correctness and in which the user approves or disapproves results, for example, in accordance with the systems described above and illustrated in FIGS. 2 and 3.

Although computers 430 and 450 are shown separately in FIG. 4, computers 430 and 450 may be combined into one computer. That is, the Bayes engine 160, the rules and results database 170, the lexical engine 130 and the keyword database 140 may be provided in a single computer.

B. Example of Integration and Use

The process can be started either from medical notes or information or from billing information as both the medical information and the billing information can be cross referenced using some identifier such as the patients' medical record number for example. There may also be situations in which the ultimate output could rely on only one input. Such a situation might occur if one utilized the system to generate a bill using only the encounter notes. However, this narrative example will, for example, assume that both inputs are available.

The medical notes or information can come from any number of pertinent sources such as physician encounter notes, medical records, procedure review systems or any source that can potentially effect the outcome of the billing process. Documents could be scanned and processed via OCR or could already be in some electronic format or be the output of some other system.

Billing information could be comprised of prior or current medical bills, government summary documents, contracts or any document that would relate to the issuance or acceptance of a medical bill. The bill could be in any form including such things as printed documents or bills in electronic format generated from any number of sources.

The process begins when a user enters the medical notes or information and/or billing information. A software routine then processes the input to insure that the input is in some electronic format as mentioned earlier.

The lexical parser then begins processing the documents from medical notes or information or billing information. Any correlation between the notes and the bills are made and recorded in a database. The parser would first read the electronic document and tokenize all the words on the page thus establishing the relative position of each word on the page. Once tokenized, the parser would then begin the process of scanning the documents keywords as stored in the keyword/phrase database. This scanning process would most likely be iterative in order to check for progressively longer phrases with each scan. The use of natural language algorithms, which are particularly useful for phrase matching, could be employed as well as other text matching systems. As an added function, the parser could also be programmed to return additional data with each found keyword(s). For example, a billing code normally associated with a keyword or phrase could be added to the data.

When the parser has completed its keyword matching, the parser would store the results, along with the documents token data in a pre-analysis database. The output would be something similar to this example assuming that the system also returned an additional billing code as described earlier.

TABLE 2

| Keyword or Phrase | Added Info | Position in document |
|---|---|---|
| Cardiac bypass | 1234 00 | 2 |
| Performed | n/a | 5 |
| Patient | n/a | 7 |
| Result | n/a | 10 |
| Coronary thrombosis | 1234 00-06 | 12 |
| Patient | n/a | 15 |
| Screened | n/a | 18 |
| Angiogram | 1281-04 | 20 |
| Department policy | n/a | 23 |

Once the medical bill and note data have been processed and stored on database, the Bayes Engine and processing system begins work. The Bayes engine takes three inputs. The parsed note data, the parsed medical bill data and any rules or constraint items as stored in the Engine's support database.

In processing the note, the Bayes Engine compares the pattern exhibited in the note and looks for matching or similar patterns in its support database. The Engine could return one, none or many matching patterns. These patterns could have been initially stored in the database as a result of several events; 1) Results from previous Engine processing, 2) pre-loaded training examples or 3) patterns added as the result of end user feedback. The found patterns have a probability of being the same as previously stored patterns.

Processing the medical bill would work much in the same way. Patterns like the bill being examined would also return a probability of likely being correct. However, the pattern matching would be a more complex match as pattern matching would not only include patterns from the billing information but would be coupled with a previous pattern of supporting notes called a billing pair.

The next step in the engine process is to manipulate the probabilities returned by the notes with the probabilities returned by the bills and their associated coupled notes. Once both values are known a probability of a particular set of input notes as compared to the billing pair could be rendered by the engine and an overall probability set (the Result) that the bill was coded correctly for a given encounter could be sent to the user for final disposition.

The user would then be presented with information similar to the following:

TABLE 3
Results of scan for MRN 123456:

Probability existing bill is correct as coded: 89.7%
Probability that other code combination could be correct: 27.6%
Number of other similar patterns: 4
Pattern one as correct match: 8%
Pattern two as correct match: 12%
Pattern three as correct match: 28%
Pattern four as correct match: 31%

The user, through the interface, would have many options to explore the correct choice as well as the alternatives include such things as:
Examine the details of the correct analysis
Examine the details of the incorrect analysis
Accept the suggested coding or override with one of the other patterns
Reject all the patterns and shift to an edit mode that would allow for corrections or entirely new entries.
Resubmit any edited item for reprocessing
Marking an edited item as the new standard
Examining the input data for the note
Edit the input note data and resubmit for processing.

In any case, whether the user modifies, replaces or accepts the result, that choice is sent back to the Bayes Engine which now updates its database and either reinforces its conclusion or modifies the conclusion. This constant feedback continually refines the systems probabilistic behavior in pattern matching. Further, if changes or modifications were made to the note data input to the Engine, then keyword/phrase addition or modification would be fed back to the Keyword database.

Other Uses or Configurations

There are a number of other configurations and modifications that could be made to the invention to enhance its use.

The simplest group of modifications would be generally based on component replacement or substitution. Examples of these are:

(a) Modifying or replacing the Bayes engine with another algorithm, or group of algorithms, that would be more efficient, faster or otherwise improved with respect to performance or learning characteristics.

(b) Enhancing or replacing the note processing subsystem with improved devices, groups of processing components or any combination that would result in improved performance or accuracy of gathering or processing the note content.

(c) Better interfacing with existing billing systems or pre-processing systems that would enhance the information supplied to the Bayes engine and generally improve the accuracy, speed or other functioning of the engines output.

A more complex set of modifications would involve the rearrangement of the components or different combinations of components resulting in improved, enhanced or expanded functionality. Examples of these would be:

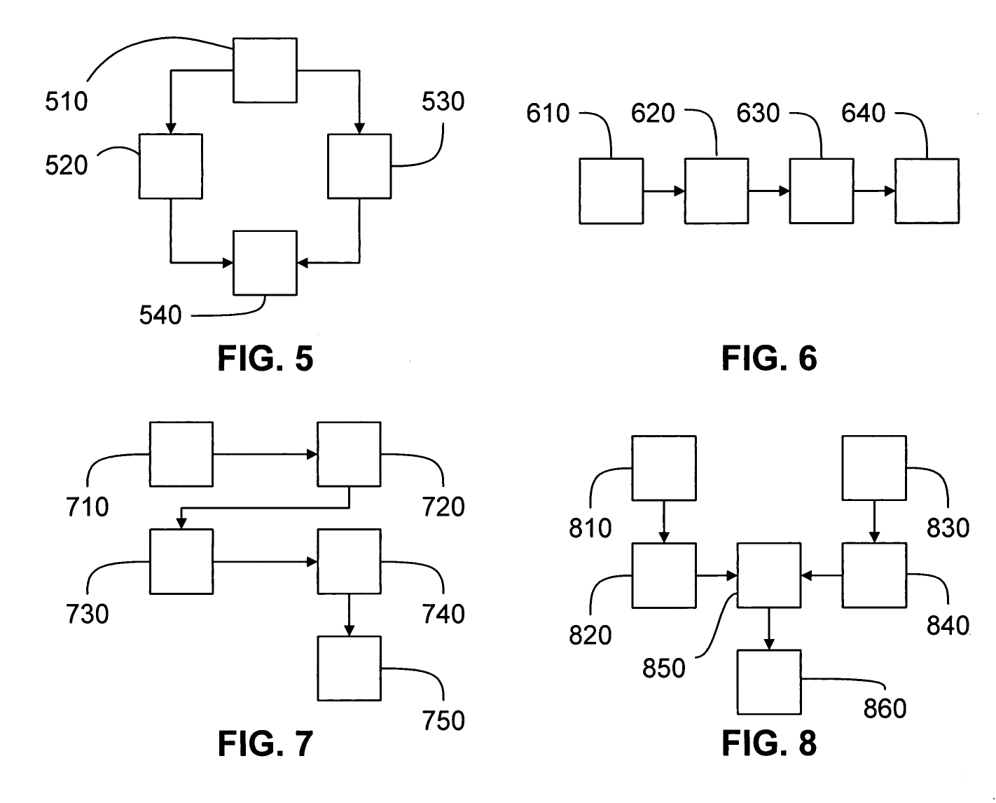

(a) Replicating or combining the entire system with other instances of itself thereby producing parallel, series or combination processing capabilities. Parallel systems could be used to increase processing and output performance. Series systems could be used to add an additional dimension(s) to the process such as adding contract information to modify or correct bills based on sets of business rules (FIGS. 5 and 6).

For example, FIG. 5 illustrates an embodiment of the present invention where data input 510 is provided to a first system 520 set to analyze a first process and a second system 530 set to analyze a second process, where the first and second systems 520 and 530 are connected in parallel. Each of the first and second systems 520 and 530 may comprise a complete probabilistic medical billing system and method using contextual data and inferential logic as shown, for example, in FIG. 1. That is, each of the first and second systems 520 and 530 may comprise one or more of the following: a lexical engine 130, a collected database of keywords, phrases and related terms of interest 140, a lexical engine output 150, a Bayes engine 160, a rules and results database 170, and the user interface 180, described in detail above. Output 540 of the first and second systems 520 and 530 may be compared, combined or reviewed in any suitable manner.

For example, FIG. 6 illustrates an embodiment of the present invention where data input 610 is provided to a first system 620 set to analyze a first process and a second system 630 set to analyze a second process, where the first and second systems 620 and 630 are connected in series. Each of the first and second systems 620 and 630 may comprise a complete probabilistic medical billing system and method using contextual data and inferential logic as shown, for example, in FIG. 1. That is, each of the first and second systems 620 and 630 may comprise one or more of the following: a lexical engine 130, a collected database of keywords, phrases and related terms of interest 140, a lexical engine output 150, a Bayes engine 160, a rules and results database 170, and the user interface 180, described in detail above. Processing is completed by the first system 620 before being inputted into the second system 630, and the second system 630 produces output 640.

(b) Multiple parsing systems could be employed with different keyword rule sets that would allow for multiple analysis of the same document. For example, if the input information was known to have originated from a cardiologist, a specialized set of parsing keywords could be called to improve the ranking and sorting of the parsed data. If multiple medical specialties were involved, the encounter notes could be processed by specialty in either a parallel or a series fashion. Similarly, any other parsing and keyword ranking could be extended to the document such as contract information, governmental regulations, risk analysis or peer review as examples (FIGS. 7 and 8).

For example, FIG. 7 illustrates an embodiment of the present invention where a first keyword and parsing routine 710 is utilized in order to process data in a first process engine 720 set to analyze a first process and a second keyword and parsing routine 730 is utilized in order to process data in a second process engine 740 set to analyze a second process, where the first and second process engines 720 and 740 are connected in series. Each of the first and second process engines 720 and 740 may comprise a complete probabilistic medical billing system and method using contextual data and inferential logic as shown, for example, in FIG. 1. That is, each of the first and second process engines 720 and 740 may comprise one or more of the following: a lexical engine 130, a collected database of keywords, phrases and related terms of interest 140, a lexical engine output 150, a Bayes engine 160, a rules and results database 170, and the user interface 180, described in detail above. Processing is completed by the first process engine 720 before being inputted into the second process engine 740, and the second process engine 740 produces output 750.

For example, FIG. 8 illustrates an embodiment of the present invention where a first keyword and parsing routine 810 is utilized in order to process data in a first process engine 820 set to analyze a first process and a second keyword and parsing routine 830 is utilized in order to process data in a second process engine 840 set to analyze a second process, where the first and second process engines 820 and 840 are connected in parallel. Each of the first and second process engines 820 and 840 may comprise a complete probabilistic medical billing system and method using contextual data and inferential logic as shown, for example, in FIG. 1. That is, each of the first and second process engines 820 and 840 may comprise one or more of the following: a lexical engine 130, a collected database of keywords, phrases and related terms of interest 140, a lexical engine output 150, a Bayes engine 160, a rules and results database 170, and the user interface 180, described in detail above. Processing is completed by the first and second process engines 820 and 840 before being inputted into a third process engine 850 set to analyze or combine the processes, and the third process engine 850 produces output 860. As with the first and second process engines 820 and 840, the third process engine 850 may comprise one or more of the following: a lexical engine 130, a collected database of keywords, phrases and related terms of interest 140, a lexical engine output 150, a Bayes engine 160, a rules and results database 170, and the user interface 180, described in detail above.

(c) Multiple instances of the Bayes engine, or other processing engines, could be used to refine the probability output or compare output from differently processed items. The engine(s) could be combined in series, parallel or combinations thereof.

(d) The system could be completely and easily reprogrammed to support entirely different sorts of analysis. Different initial documents, such as incident reports, could be parsed and analyzed in order to produce a generalized risk assessment, for example. This wholesale change in system function would not have to be developed by the user but could be provided by other sources by simply providing a set of keywords and a sufficient number of examples to the Bayes engine. In fact, a commercial version of the system may be pre-loaded with data making analysis available with the first deployment of the system.

(e) The invention could be extended by connecting individually deployed systems. This could reduce the number of completely unknown results by being able to draw on the experience of other systems. This could be accomplished taping the keyword database, the process engine database or both databases belonging to other deployed systems to increase the overall information base. Similarly, the invention could also be deployed via a network, such as the internet, that could either process information on an individual user basis against a user specific set of rules or a larger set of rules as accumulated from several, or even all, users of the system. This kind of connectivity could also create a path to support parallel or distributed processing. Additionally, new rules or processing directives could be loaded via a direct or networked connection to facilitate rapid training or for group deployments of the invention. This would allow a subject matter expert to create and distribute keyword sets, training examples, processing directives or other data which would add or modify the inventions function and usefulness. This would also facilitate use of the system by individuals that had little or no understanding while still producing results that were of expert quality.

Still further modifications may include one or more of the following:

(a) The system could be supplied to the user in a number of different ways and could be run from many different client/server; network or internet platforms. The initial keyword and phrase database could be supplied by the system manufacture or by the user. If supplied by the manufacturer, the database could be loaded with many different sets of data. For example, the system could be loaded with general medical billing information, information focused on one or more specialties or information related to contractual arrangements with insurance companies Correspondingly, any set of keywords, phrases and associated results could be loaded directly into the Bayes engine historical results table(s) in order to supply a significant database with which to begin using the system.

(b) The system could be supplied automatically with sets of encounter notes and related bills. A threshold could then be set at the output of the Bayes engine to automatically flag items that were identified as not conforming to that threshold. The mode of operation described above would allow for the rapid, bulk screening of large quantities of bills and make auditing historical transactions possible. The mode of operation described above could also be a methodology for quickly establishing a large statistical base for the Bayes engine. In general, a larger statistical base improves the accuracy of output.

(c) Multiple systems or subcomponents could be used in combination to screen for more than one problem or result. For example, a bill, could first be screened against the physician notes and then against contract provisions from an insurance company. A known set of notes and bills could be automatically entered into the system in order to tune the output or discover system errors induced by users. The process described above could also be conducted remotely in order to supply a useful service to users.

(d) The physician treatment or encounter notes could be fed to the system from any number of sources including scanning/OCR system, document imaging system or direct voice translation of the notes from a live or recorded source. Similarly, medical bills could be fed to the system by the user, an external billing system or through direct voice translation.

(e) The system process and flow could also be modified in such a way as to make the system the source of bill creation rather than a mechanism for screening or checking bills. Bill creation could be accomplished by setting a threshold confidence level at which the system would be allowed to generate medical bills and only alert the user to conditions of low confidence or conflict. The system would also follow that high confidence, system produced bills could be directed to an external accounting or clearinghouse system making the process an integral part of a larger billing and management operation.

(f) The system could be easily modified to produce training tools for new coders or physicians by allowing users to guess at the correct result based on the keywords and their relative position in the founding document.

(g) Since the system uses the procedures, their associated codes and keeps track of both patient and doctor, the system could be modified to produce quality control, treatment outcome information and information to support the credentialing or privileging re appointment process.

As to a further discussion of the manner of usage and operation of the present invention, the same should be apparent from the above description. Accordingly, no further discussion relating to the manner of usage and operation will be provided.

With respect to the above description then, it is to be realized that the optimum relationships for the parts of the invention, to include variations in form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

1. A medical billing system comprising:
a device for capturing data from patient encounter notes or similar information generated by physicians or care givers;
a first database comprising keywords;
a lexical engine for capturing keywords from the data while preserving a relative order or position of the keywords resulting in an output comprising a series of keywords in relative order or position;
a second database comprising keywords in relative order or position based on accurate bills from past encounters or from a predetermined list of accurate bills;
a statistical engine for comparing the output from the lexical engine with the second database and to produce a resulting bill with a confidence level prediction.

2. The medical billing system of claim 1, wherein the statistical engine is based on Bayesian mathematics.

3. The medical billing system of claim 1, wherein the statistical engine compares the resulting bill against a bill generated by an external system.

4. The medical billing system of claim 1, wherein the lexical engine captures previously unidentified keywords from the data while preserving a relative order or position of the keywords resulting in a bypass output comprising a series of keywords in relative order or position for later review and approval or disapproval.

5. The medical billing system of claim 1, wherein the statistical engine further comprises an interactive means for improving accuracy of the statistical engine.

6. The medical billing system of claim 5, wherein the interactive means comprises a means for displaying a full document from the lexical engine with a new keyword highlighted.

7. The medical billing system of claim 6, wherein the new keyword and a location of the new keyword are added to at least one of the first and second databases thus updating the statistical engine.

8. The medical billing system of claim 5, wherein the interactive means comprises a means for entry of a correct billing code conclusion.

9. The medical billing system of claim 5, wherein the interactive means comprises a means for adding a new probability conclusion or modifying a current probability conclusion.

10. A medical billing system comprising:
a means for capturing data from patient encounter notes or similar information generated by physicians or care givers;
a means for storing keywords;
a means for capturing keywords from the data while preserving a relative order or position of the keywords;
a means for storing a series of keywords in relative order or position;
a means for storing keywords in relative order or position based on accurate bills from past encounters or from a predetermined list of accurate bills;
a means for comparing the series of keywords in relative order or position with keywords in relative order or position based on accurate bills from past encounters or from a predetermined list of accurate bills; and
a means for producing a resulting bill with a confidence level prediction.

11. A method of medical billing comprising the steps of:
capturing data from patient encounter notes or similar information generated by physicians or care givers;
storing keywords in a first database;
capturing keywords from the data while preserving a relative order or position of the keywords;
outputting a series of keywords in relative order or position;
storing keywords in relative order or position based on accurate bills from past encounters or from a predetermined list of accurate bills in a second database;
comparing the series of keywords in relative order or position from the output step with the second database; and
producing a resulting bill with a confidence level prediction.

12. The method of claim 11, wherein the comparing step is based on Bayesian mathematics.

13. The method of claim 11, wherein the comparing step compares the resulting bill against a bill generated by an external system.

14. The method of claim 11, wherein the keyword capturing step captures previously unidentified keywords from the data while preserving a: relative order or position of the keywords resulting in a bypass output comprising a series of keywords in relative order or position for later review and approval or disapproval.

15. The method of claim 11, wherein the comparing step further comprises a step of interactively improving accuracy of the comparing step.

16. The method of claim 15, wherein the interactive improvement step comprises a step of displaying a full document from the keyword capturing step with a new keyword highlighted.

17. The method of claim 16, wherein the new keyword and a location of the new keyword are added to at least one of the first and second databases thus updating the comparing step.

18. The method of claim 15, wherein the interactive improvement step comprises a means for entry of a correct billing code conclusion.

19. The method of claim 15, wherein the interactive improvement step comprises a step of adding a new probability conclusion or modifying a current probability conclusion.

20. A medical billing system comprising:
a database comprising accurately coded medical bills, wherein each of the bills has a set of keywords, phrases and related terms of interest in relative order,
a first data analysis system for extraction of keywords, phrases and related terms of interest from inputted medical billing information and for providing output in the form of a stream of extracted keywords, phrases and related terms of interest in relative order; and
a second data analysis system for statistical comparison of the output of the first data analysis system to the database resulting in a probability that the inputted medical billing information is correct.
